(19) United States
(12) Patent Application Publication
(10) Pub. No.: US 2026/0350056 A1
(43) Pub. Date: Nov. 5, 2026

(54) ARTIFICIAL INTELLIGENCE FOR GENERATION OF OFFLINE INSTRUCTIONS FOR CREATION AND CONSUMPTION OF DATA

(71) Applicant: SAP SE, Walldorf (DE)

(72) Inventors: Qiu Shi Wang, Singapore (SG); Lin Cao, Singapore (SG)

(21) Appl. No.: 19/196,161

(22) Filed: May 1, 2025

(51) Int. Cl. G06F 16/3329; G06F 40/35; H04L 51/02

(52) U.S. Cl. CPC G06F 16/33295; G06F 40/35; H04L 51/02

(57) ABSTRACT

In an example embodiment, an offline artificial intelligence (AI) agent is provided that utilizes a locally stored (on a mobile device) fine-tuned LLM that is able to generate OData or similar transactions. Additionally, the OData or similar transactions that are generated are in a modified form that eliminates calls that require network connectivity, such as HTTP and REST calls. This allows for generation of OData transactions during times when the mobile device is offline.

### TECHNICAL FIELD

Embodiments pertain to artificial intelligence and, in some examples, to the user of artificial intelligence for the generation of offline instructions for creation and consumption of data.

### BACKGROUND

In a computer system, software servers are often used to manage applications that interact with one or more software clients over a computer network, such as the Internet. An Open Data Protocol (OData) server is a type of web server that implements the OData protocol to enable the creation and consumption of RESTful Application Program Interfaces (APIs) for data sources. OData is a protocol for creating and consuming data APIs that are consistent with RESTful principles and expose data as resources that can be accessed using standard HyperText Transfer Protocol (HTTP) methods like GET, POST, PUT, PATCH and DELETE.

An OData server allows developers to expose data from various sources such as databases, file systems, or web services as OData feeds, which can be consumed by client applications. The OData server maps the HTTP requests to the corresponding data operations and returns the data in a standardized format, typically JavaScript Object Notation (JSON) or Extensible Markup Language (XML). OData servers are used in various contexts, such as enterprise data integration, business intelligence, and mobile application development. They enable the creation of scalable and flexible APIs that can be consumed by a wide range of clients, including web and mobile applications, desktop software, and other backend systems.

### BRIEF DESCRIPTION OF THE DRAWINGS

The present disclosure is illustrated by way of example and not limitation in the figures of the accompanying drawings, in which like references indicate similar elements.

FIG. 1 is a block diagram illustrating a system for offline OData transaction generation, in accordance with an example embodiment.

FIGS. 2 and 3 is a screen capture of an example of a conversational UI and the rendering of a specialized UI flow and/or elements, in accordance with an example embodiment.

FIG. 3 displays the result of rendering the YAML file.

FIG. 4 is a screen capture illustrating a first screen of a dynamic user interface generated from a result from a local AI model, in accordance with an example embodiment.

FIG. 5 is a screen capture illustrating a second screen of the dynamic user interface, in accordance with an example embodiment.

FIG. 6 is a flow diagram illustrating a method of generating offline OData transactions using an AI agent on a mobile device, in accordance with an example embodiment.

FIG. 7 illustrates a machine learning system, according to some examples.

FIG. 8 is a flowchart depicting a machine learning pipeline, according to some examples.

FIG. 9 is a system architecture diagram showing a layered view of an AI integrated system, according to some examples.

FIG. 10 shows a block diagram showing one example of a software architecture for a computing device.

FIG. 11 shows a block diagram of a machine in the example form of a computer system within which instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

Artificial intelligence (AI) may be used to generate OData or similar transactions. However, technical challenges exist in extending such artificial intelligence solutions to offline environments. Specifically, there are certain industries, such as oil, gas, and mining industries, where technicians perform work orders in remote locations with no or poor network connectivity. In such use cases, AI models designed to generate OData transactions in an online environment cannot be relied upon to generate OData transactions in an offline manner. This is for several reasons.

First of all, the size of reliable AI models, such as Large Language Models (LLMs), does not fit on a mobile device and thus require the use of a computer network to connect the mobile device to a server running the AI model. Second of all, the OData transactions generated by such AI models contain elements that make them incompatible with executing the transactions in an offline manner. Specifically, the standard OData code relies on protocols like HTTP and REST, both of which require network connectivity.

In an example embodiment, an offline AI agent is provided that addresses both of these technical limitations. The offline AI agent is able to interact with a locally stored fine-tuned LLM that is able to generate OData or similar transactions. Additionally, the OData or similar transactions that are generated are in a modified form that eliminates calls that require network connectivity, such as HTTP and REST calls.

The described examples focus on a technology that enables an AI agent to perform offline OData transactions on mobile devices. This technology is designed to assist users in environments with limited or no network connectivity. It is particularly useful in industries like oil, gas, and mining, where technicians often work in remote locations. In such scenarios, relying on cloud-based AI models and data services is not feasible. The technology ensures that all necessary components are available on the mobile device, providing a user experience similar to online interactions.

One aspect of this technology is a metadata-driven AI agent. This agent interacts with users through multimodal input and output. Users can communicate with the AI agent using text, voice, photos, or videos. For instance, a field technician can take a photo of equipment and ask the AI agent for assistance in detecting anomalies. The AI agent may use a generative AI model to create OData queries, actions, and functions. The agent also generates a user interface for these transactions, allowing users to confirm actions.

The technology includes a package of modules installed on a mobile device. These modules support offline use cases without network connectivity. A no-code/low-code development platform is provided to create metadata for the AI agent. This platform also manages and orchestrates the modules. The AI agent can generate OData queries and actions for offline data services. This ensures that OData transactions continue without interruption due to poor network connectivity. When a network is available, the system can synchronize with cloud data services.

The implementation involves several steps. Users interact with a conversational user interface using various input methods. This interaction triggers capabilities in the AI agent. For example, in an anomaly detection use case, the AI agent uses metadata to define actions. These actions are rendered on the mobile device, allowing users to choose further actions. Once a user opts to initiate anomaly detection, they can take photos. The local AI model analyzes these photos to detect anomalies. The metadata for this process is defined by developers using low-code/no-code tools.

Based on the anomaly detection results, a dynamic user interface is generated. This interface is influenced by both the data schema defined by developers and the AI model's output. The interface includes operation forms with key-value pairs. The AI agent generates the corresponding code for OData queries, actions, and functions. It interacts with user interface controls to retrieve key-value pairs.

Users confirm operations through the interface or voice input. The offline OData code is executed against a local data service on the mobile device. This code is interpreted by a runtime library to execute standard JavaScript code. The data is committed to the OData entities of the local data service. All these steps can be performed without a network connection. When a network is available, the local data service synchronizes with the cloud.

The technology addresses specific challenges of offline OData transactions. Standard OData code relies on network protocols like HTTP and REST. These are not suitable for offline scenarios. The described examples generate specialized code for offline use cases. This code includes all OData operations: Create, Read, Update, Delete (CRUD), and functions. The technology employs specific OData actions for offline transactions. These actions resolve issues like synchronization conflicts and transaction merges.

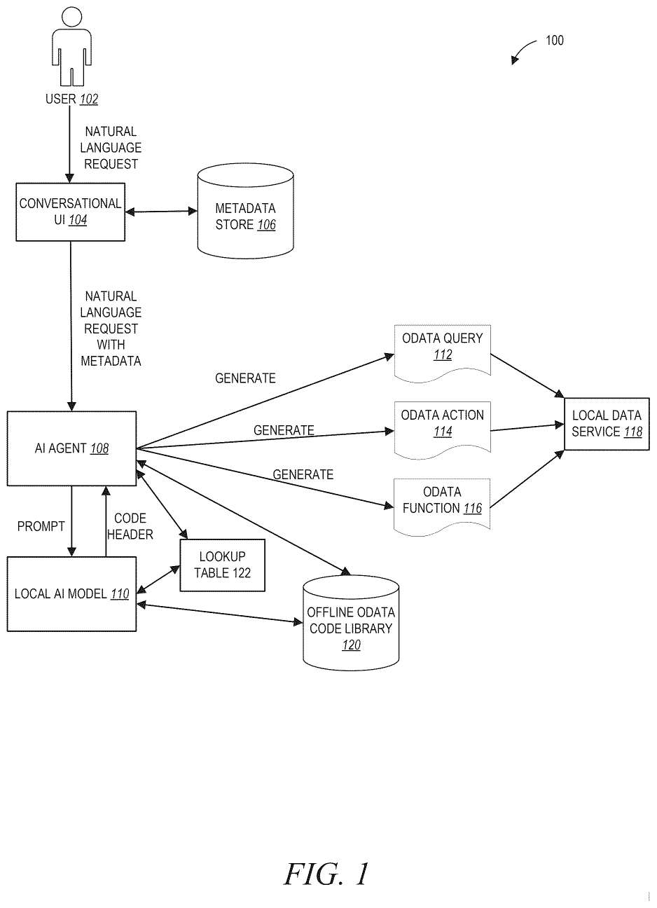

FIG. 1 is a block diagram illustrating a system 100 for offline OData transaction generation, in accordance with an example embodiment. Here, an end user 102 may interact with a conversational user interface (UI) 104. The conversational UI may be, for example, a chatbot, such as a lightweight version of the Joule chatbot. The Joule chatbot is a digital assistant developed by SAP SE of Walldorf, Germany, to assist users in interacting with their ERP systems in a more user-friendly manner. The Joule chatbot is a smart helper that users can communicate with, either by typing or speaking, to obtain information or perform tasks within a business software system.

Joule is designed to comprehend an inquiry and determine an appropriate way to respond. This is achieved by aligning the request with a set of predefined tasks, referred to as “scenarios,” that Joule is equipped to manage.

Here, the end user 102 interacts with the conversational UI 104 in a manner that suggests that an OData transaction should be generated. This may include, for example, providing the conversational UI 104 with text, voice, photo, or video data in a manner that indicates that an OData transaction should be generated based on this provided data. The details of what would or would not indicate to the conversational UI 104 that an OData transaction should be generated are not relevant here. It only matters that the conversational UI 104 at some point determines that an OData transaction should be generated.

In some example embodiments, the conversational UI 104 will generate a specialized UI flow and/or elements to retrieve additional information from the end user 102. In the aforementioned anomaly detection use case, for example, the conversational UI will, upon detecting an indication that the end user 102 wishes to engage in anomaly detection (such as by the end user 102 selecting a button indicating so or supplying text indicating so), retrieve a specialized UI flow and/or elements from a metadata store 106. For example, in the anomaly detection use case, the metadata file may be as follows:
action_groups:
   actions:
   type: message
      scripting_type: spel
      message:
         type: text
         content: |
         You have requested for anomaly detection.
         markdown: true
   type: message
      message:
         type: buttons
         content:
         title: “Please choose an option:”
         buttons:
         type: clientdata
         title: “Initiate anomaly detection”
         client_data:
         url: “/MDKDevApp/Pages/EquipmentChecking.page”
         imageUrl: “sap-icon://alert”
      type: postback
      text: Cancel the anomaly detection
      title: “Cancel anomaly detection”
      value: “reset this conversation”
      imageUrl: “sap-icon://decline”

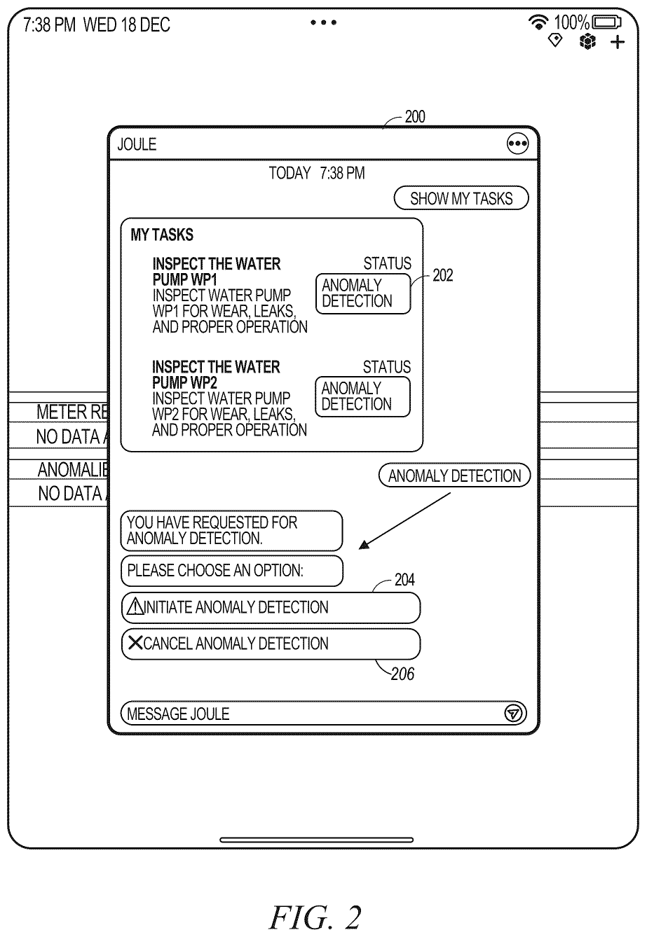

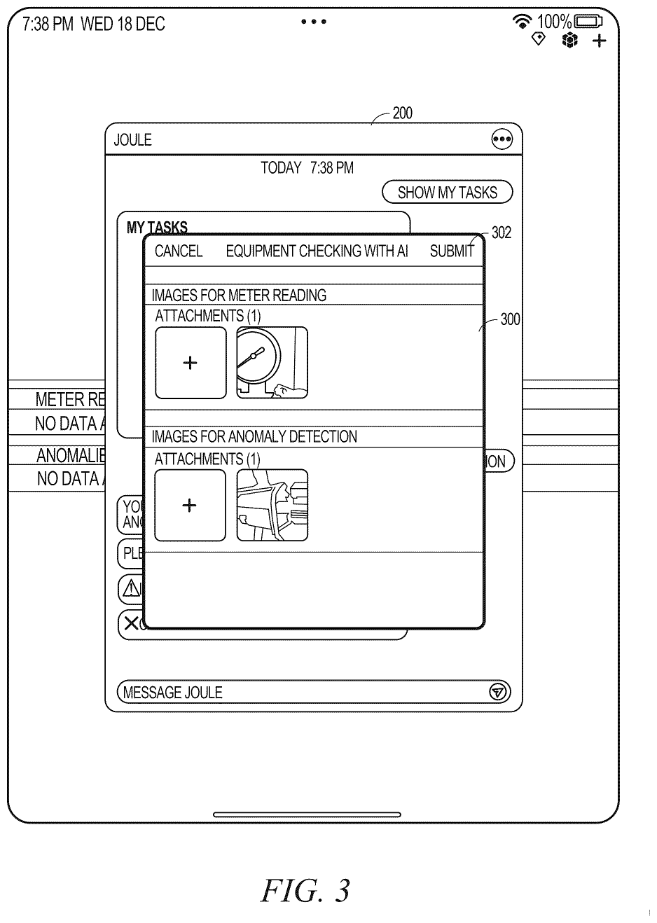

This may be defined in, for example Yet another Markup Language (YAML) format. When rendered on a mobile device, a graphical user interface may be displayed. FIGS. 2 and 3 is a screen capture of an example of a conversational UI and the rendering of a specialized UI flow and/or elements, in accordance with an example embodiment. Specifically, in FIG. 2, in the conversational UI 200 the user has written or spoken the words “anomaly detection” 202. The conversational UI 200 then renders some options regarding anomaly detection, specifically initiate anomaly detection 204 and cancel anomaly detection 206. If the user selects initiate anomaly detection 204, then the previously received YAML file may be accessed. FIG. 3 displays the result of rendering the YAML file. Specifically, a specialized UI flow 300 is presented, wherein the user is able to add images for different types of equipment checking. When the user clicks submit 302, the added image(s) is/are added as context to a request to the AI agent 108 to begin the process of generating an OData transaction. This process involves generating two items: the OData transaction and also a custom UI (different than the specialized UI flow 300 described above), as will be described in more detail below.

The AI agent 108 then interacts with a local AI model 110 to generate an OData transaction based on the request and the context. In the case of anomaly detection, this may include analyzing the photos and detecting anomalies, if present. This interaction may be based on additional metadata stored in the metadata store 106. For example, the following metadata for analyzing photos and detecting anomalies may be extracted from the metadata store 106 and used by the local AI model 110:
{
“_Type”: “Action. Type. AICore. Chat. Completions”,
“ResourceGroup”: “default”,
“APIVersion”: “2024-02-01”,
“Target”: {
“Service”: “/MDKDevApp/Services/SAPAI.service”,
“Path”: “/chat/completions”
},
“Properties”: {
“Model”: “local-01”,
“Messages”: []
},
“ShowActivityIndicator”: true,
“ActivityIndicatorText”: “Processing . . . ”,
“ActionResult”: {
“_Name”: “OData”
},
“OnFailure”: “/MDKDevApp/Actions/Failure.action”
}

The metadata includes a detailed description of how to interact with the AI agent 108, how to manipulate the prompt and knowledge base for retrieval-augmented generation, etc. This metadata may be defined by developers using low-code/no-code development tools and encapsulated into a runtime library and into manifest files, which can be deployed to mobile device.

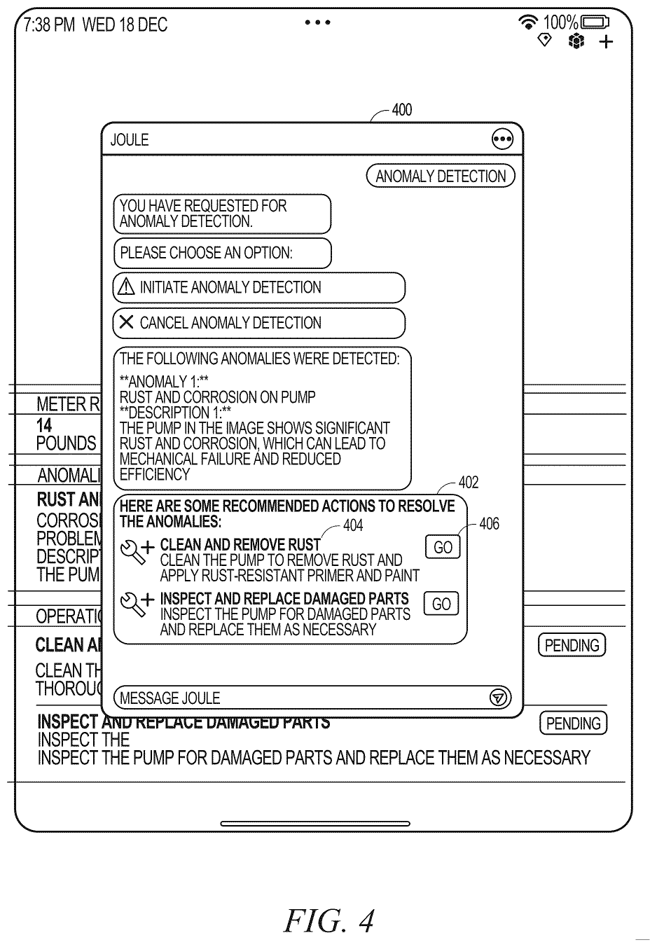

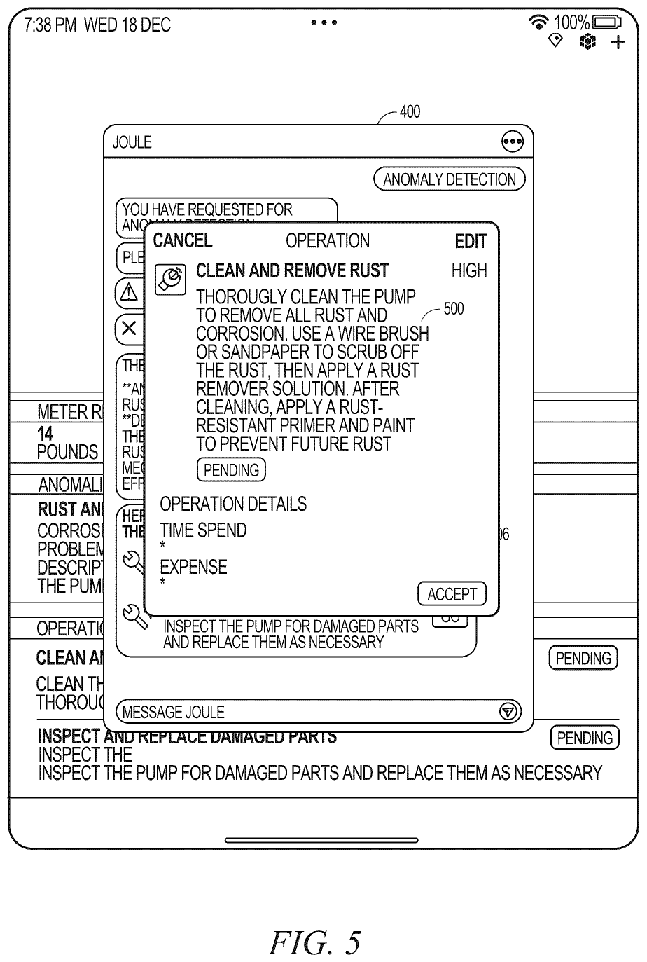

Based on the anomaly detection result from the local AI model 110, a dynamic user interface may be generated. FIG. 4 is a screen capture illustrating a first screen of a dynamic user interface 400 generated from a result from a local AI model 110, in accordance with an example embodiment. Here, a set of recommended actions 402 are presented along with corresponding user interface elements. A user can, for example, click on a button next to one of the user interface elements to launch additional information about how to proceed with the recommended actions. For example, if the user chooses the “clean and remove rust” recommendation 404, the user may click on button 406. FIG. 5 is a screen capture illustrating a second screen of the dynamic user interface 400, in accordance with an example embodiment. Here, the details of how to clean and remove rust are presented in portion 500.

In the above, the dynamic user interface 400 itself is determined from the metadata, which may include the following schema, but also from the results of the local AI model 110.
const structuredDataSchema={
“type”: “object”,
“properties”: {
“formCell”: {
“type”: “array”,
“description”: “Refers to each item in the schema array. The title property must completely match the one defined in schema”,
“items”: {
“type”: “object”,
“properties”: {
“title”: {“type”: “string”,
“description”: “Title of the
property”
},
“value”: {
“type”: “string”,
“description”: “Value of the property”
}
},
“required”: [“title”, “value”]
}
}
},
“required”: [“formCell”]
};

Thus, while the visual may, for example, be determined by the metadata, the content, such as the recommended actions, are determined by the output of the local AI model 110.

The local AI model 110 not only aids in the generation of the dynamic user interfaces, but also the corresponding code for OData queries, OData actions, and OData functions (collectively called OData transactions).

The details of how this code is generated is described in more detail below, but for the anomaly detection use case described above, the generated code may be as follows:
export default async function CreateOperation(context) {
let timeSpend=context.evaluateTargetPath(‘#Control:TimeSpend/#Value’);
let expense=context.evaluateTargetPath(‘#Control:Expense/#Value’);
let action1={
“Name”:
“/MDKDevApp/Actions/OData/ChangeSet/CreateEntity.action”,
“Properties”: {
“Properties”: {“TimeSpend”: timeSpend,
“Expense”: expense}
}
};
let action2={
“Name”:
“/MDKDevApp/Actions/BookShop/OData/ChangeSet/CreateEntiry. action”,
“Properties”: {
“Properties”: {
“property1”: value1,
“property2”: value2
}
}
};
return context.executeAction(action1).then((result)=>{
return context.executeAction(action2);
});
}
{
“_Type”: “Action.Type.ODataService.CreateEntity”,
“Target”: {
“EntitySet”: “Operations”,
“Service”: “/MDKDevApp/Services/Equipment.service”
},
“Properties”: {
“TimeSpend”: “#Control:TimeSpend/#Value”,
“Expense”: “#Control:Expense/#Value”},
“CreateLinks”: [
{
“Property”: “Equipment”,
“Target”: {
“EntitySet”: “Equipments”,
“ReadLink”: “pending_1”
}
}
],
“ShowActivityIndicator”: true,
“ActionResult”: {“_Name”: “OData”},
“OnFailure”: “/MDKDevApp/Rules/Failure.js”
}

This is different from the standard JavaScript OData code, in that no

HTTP or REST calls are present. Rather, the code tightly interacts with UI controls (e.g., context. evaluateTargetPath) using a specific API function to evaluate the UI controls on the related UI page to retrieve the key-value pairs of those UI controls.

Referring back to FIG. 1, the generated OData query 112, OData action 114, and/or OData function 116 may then be executed on a local data service 118. In some example embodiment, prior to this execution the end user 102 may be prompted to confirm the corresponding operation(s), using, for example, an accept button or voice input.

During execution, the generated code will be interpreted by a runtime library to execute JavaScript code for the OData transaction to commit the data to the OData entities of the local data service 118.

All the steps mentioned above can be done on a mobile device without a mobile data network connection. Whenever there is a network available, the mobile local data service will be synchronized with the data service on the cloud.

As mentioned above, the generated OData code needs to be in a non-standard format, specifically one that does not rely upon network calls such as HTTP and REST calls, but also needs to be generated using a local AI model 110 that is capable of being stored and run on a mobile device. It also needs to encompass all traditional OData operations, including, for example, Create, Read, Update, and Delete (CRUD) operations. This ensures that there are no restrictions on usage despite being employed in an offline environment.

To achieve these goals, in an example embodiment a set of specific OData actions are employed. This set of specific OData actions is designed exclusively for offline transactions. These actions address unique issues associated with offline use cases, such as resolving conflicts during synchronization with backend data services, handling transaction merges to enhance performance, etc. The local AI model 110 will generate code using these specially designed sets of offline OData actions. In some example embodiments, this generation comprises selecting one or more offline OData actions from the specially designed set. This reduces the workload on the mobile device as the local AI model 110 does not need to generate complete code snippets on its own. A traditional AI model would need to generate a complete and detailed code snippet, such as the following:
// Define the OData service URL
const serviceUrl=“https://your-odata-service-url/odata.svc/WorkOrders”;
// Define the data to be sent in the request body
const data={
HoursSpent: 2,
Expense: 100,
Currency: “USD”,
Description: “Spent 2 hours on this workorder, and the expense for spare parts is 100 dollars”
};
// Function to create a new OData record
async function createODataRecord() {
try {
const response=await fetch(serviceUrl, {
method: “POST”,
headers: {
“Content-Type”: “application/json”,
“Accept”: “application/json”,
“Authorization”: “Bearer YOUR_ACCESS_TOKEN”// Replace with your actual access token
},
body: JSON.stringify(data)
});
if (response.ok) {
const result=await response.json();
console.log(“Record created successfully:”, result);
} else {
console.error(“Failed to create record:”, response.statusText);
}
} catch (error) {
console.error(“Error creating record:”, error);
}
}
// Call the function to create the Odata record
createODataRecord();

Generating the above code, however, has two major requirements. The first is a full-scale and powerful AI model capable of generating general-purpose code. The second is sufficient computing resources and power to run the AI model. Both of these requirements are not feasible on a mobile device. For the first requirement, mobile devices don't have enough memory to host a full-scale model. For the second requirement, mobile devices don't have powerful processors and sufficient battery power, so it will take a very long time to process and result in significant performance penalties, making the whole solution infeasible.

In order to address these technical challenges, rather than generating a complete and detailed code snippet, only a code header is generated by the local AI model 110.

A built-in library containing the specially designed set of OData transactions may be accessed by the local AI model 110. This set may be stored in, for example, the offline OData code library 120. The local AI model 110 is then able to generate the code header to indicate which offline OData transactions to execute from the offline OData code library 120 and also to indicate properties to pass as input values. In this way, a full-scale AI model capable of generating general-purpose code is not needed. Rather, a fine-tuned model that understands the context of the current application specifically may be used to generate a limited list of offline OData transaction.

The header may identify an index that can be used to access a lookup table 122 to identify the specific code in the offline OData code library 120.

The following is an example of a generated code header, which can be indexed into the implemented code in the offline OData code library 120.
let action1={
“Name”: “/MDKDevApp/Actions/OData/ChangeSet/CreateEntity. action”,
“Properties”: {
“Properties”: {
“TimeSpend”: 2,
“Expense”: 100}
}
};

For this example,
“/MDKDevApp/Actions/OData/ChangeSet/CreateEntity.action, and the input properties to be passed as input values (for this example “TimeSpend”: 2, “Expense”: 100).

In this example, the generated code will create an entity in a local database on the mobile device, to ensure that the OData transaction can continue without network connectivity. It will then synchronize with the backend data service later when there is a network connection available.

Another unique advantage using the code-header generation instead of complete code generation is that there is no requirement for code verification. The hallucination of generation models is inevitable, making it dangerous to directly execute code generated by a general-purpose model. In contrast, the present approach ensures that the generated code is guarded by a limited set of code headers and pre-implemented code in the runtime library. This approach meets accuracy requirements, is safe to execute directly, and offers better performance due to the pre-implemented code in the runtime library being optimized for the target mobile platform.

When executing the generated code, the following steps may be performed:
1. The code header is first loaded.
2. Input properties are formatted and defined as input values.
3. The corresponding code implementation is located via a look-up table.
4. Simultaneously, a user interface paired with the code header is generated and rendered on a mobile device.
5. The end user can confirm the offline OData action to execute.
6. The end user can also modify the action and redo the code generation or cancel the action via UI controls or voice input.

As to the local AI model 110, in an example embodiment this is a distilled lightweighted AI model with specific knowledge that is fine-tuned. More specifically, the training data may comprise a set of possible prompts that end users send for offline OData action generation and corresponding code snippets and/or indexes into the offline OData code library 120. Here, an online LLM may be used as part of this process.

LLMs used to generate information are generally referred to as Generative Artificial Intelligence (GAI) models. A GAI model may be implemented as a generative pretrained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order. Each direction has its own hidden state, and the final output is a combination of the two hidden states. By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake. The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier. The present solution works with any type of GAI model.

In an example embodiment, a teacher-student training approach is used to train the local AI model 110. The teacher-student training approach is a method used to train an LLM by leveraging a teacher model to guide the learning of a student model. In this approach, the teacher model is typically a well-established and pre-trained model that has already achieved strong performance on certain tasks. The teacher generates high-quality predictions or responses, which serve as the ground truth for the student model to learn from. The student model, often smaller or less refined than the teacher, learns by mimicking the teacher's behavior through a process called knowledge distillation.

During training, the teacher's output is used as a target for the student to predict. The student model is optimized to minimize the difference between its predictions and the teacher's outputs, typically through a loss function that measures the error in predictions. The teacher model provides not just the final labels or answers but also intermediate states or probabilities, giving the student a more detailed understanding of the teacher's decision-making process. This enables the student model to generalize better and improve its performance on tasks, even when it has fewer parameters or computational resources than the teacher.

The advantage of this approach is that the student model can learn from the teacher without needing to train on massive datasets from scratch. It can capture complex patterns and insights from the teacher, making it possible for smaller models to perform well on challenging tasks.

Below are simplified examples of the code headers, which can be indexed into the implemented code in the built-in runtime library
CreateEntity.action: Creates a new entity in the Offline OData service.
ReadEntity.action: Reads a single entity from the Offline OData service.
ReadEntities.action: Reads multiple entities from the Offline OData service.
UpdateEntity.action: Updates an existing entity in the Offline OData service.
DeleteEntity.action: Deletes an entity from the Offline OData service.
FunctionImport.action: Executes a function import in the Offline OData service.
ActionImport.action: Executes an action import in the Offline OData service.
ChangeSet.action: Executes a batch of Offline OData operations as a single transaction.
DownloadMedia.action: Downloads media content from the Offline OData service.
UploadMedia.action: Uploads media content to the Offline OData service.
CreateRelatedEntity.action: Creates a related entity in the Offline OData service.
ReadRelatedEntities.action: Reads related entities from the Offline OData service.
UpdateRelatedEntity.action: Updates a related entity in the Offline OData service.
DeleteRelatedEntity.action: Deletes a related entity from the Offline OData service.

In actual implementation, these will be sophisticated documents with detailed information. These documents may be used as specific knowledge to fine-tune the local AI model 110 in the following steps:
1. Data Preparation and Preprocessing:
   Gather all these documents and remove any unnecessary elements such as headers, footers, page numbers, and other non-textual data.
   Tokenize the text by splitting it into tokens.
   Normalize the text by converting it to lowercase and removing punctuation to reduce variability.
2. Load the Lightweight Model:
   Load our lightweight model as the base model for fine-tuning.
3. Set Hyperparameters:
   Adjust learning rate, batch size, number of epochs, and gradient accumulation steps.
4. Supervised Fine-Tuning (SFT):
   Due to the specificity of the knowledge of offline OData code headers and their indexed implementation in the built-in runtime library, use Supervised Fine-Tuning (SFT) (e.g., SFTTrainer) to fine-tune the local AI model 110.
5. Evaluate the Model:
   Evaluate the model with test data and use cases.
6. Compress the Model:
   Compress the model for mobile apps.

Compression can be performed using a variety of techniques aimed at reducing the size of the LLM while maintaining performance. One possible approach is pruning, where less important weights or neurons in the model are removed. This reduces the overall number of parameters without significantly affecting the model's ability to generate meaningful outputs. Another technique is quantization, which reduces the precision of the model's parameters. Instead of using 32-bit floating point numbers, for example, lower-precision numbers like 16-bit or even 8-bit values can be used, which dramatically reduces the model's memory footprint.

The result is a solution for offline data transactions that provides a seamless user experience in environments with limited network connectivity. It ensure the continuity of OData transactions.

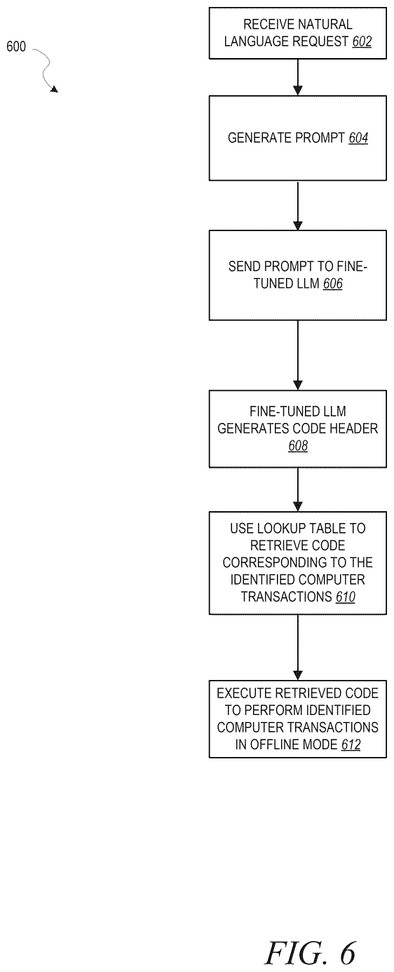

FIG. 6 is a flow diagram illustrating a method 600 of generating offline OData transactions using an AI agent on a mobile device, in accordance with an example embodiment. Although the example method depicted in FIG. 6 shows a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At operation 602, the method 600 begins with receiving a natural language request via a chatbot user interface on a mobile device operating in offline mode. The conversational user interface may be implemented as a chatbot that allows users to input data using text, voice, photo, or video. The input data serves as a prompt indicating that computer code for one or more computer transactions to manipulate data should be generated.

At operation 604, a prompt is generated based on the natural language request. The prompt indicates that computer code for one or more computer transactions to manipulate data should be generated.

At operation 606, the prompt is sent to a fine-tuned large language model (LLM) operating locally on the mobile device. The LLM is a distilled lightweight model that has been fine-tuned with specific knowledge of offline OData code headers and their indexed implementation in a built-in runtime library. The fine-tuned LLM processes the prompt to generate a code header.

At operation 608, the code header is generated by the fine-tuned LLM based on the prompt. The code header identifies code for one or more computer transactions in the runtime library and specifies properties to pass as input to these transactions. The code header does not contain HTTP or REST calls, ensuring compatibility with offline execution.

At operation 610, a lookup table is used to retrieve code corresponding to the identified computer transactions. The lookup table maps the code header to specific implementations in the offline OData code library. This library contains pre-implemented code for various OData operations, such as Create, Read, Update, and Delete (CRUD).

At operation 612, the retrieved code is executed to perform the identified computer transactions in a manner that does not utilize network connectivity. The execution occurs on a local data service on the mobile device. The runtime library interprets the code to execute standard JavaScript operations, committing data to the OData entities of the local data service.

The decision-making process leading from one operation to another involves evaluating the input data and determining the appropriate actions based on the metadata and the output of the local AI model. The conversational user interface may render options for the user to select, influencing the subsequent operations. For example, if the user opts to initiate anomaly detection, the AI agent may analyze photos and generate corresponding OData transactions.

In some examples, the method 600 may include generating a dynamic user interface based on the prompt and the output of the local AI model. This interface may present a graphical depiction of different options, allowing the user to select an action. The execution of the retrieved code may be contingent upon the user's selection.

The method 600 ensures that all operations can be performed offline, with synchronization to cloud services when network connectivity is available. The described examples provide a seamless user experience in environments with limited connectivity, supporting offline data transactions and metadata-driven development.

The local AI model 110 may be any model selected from a number of different types of machine learning models.

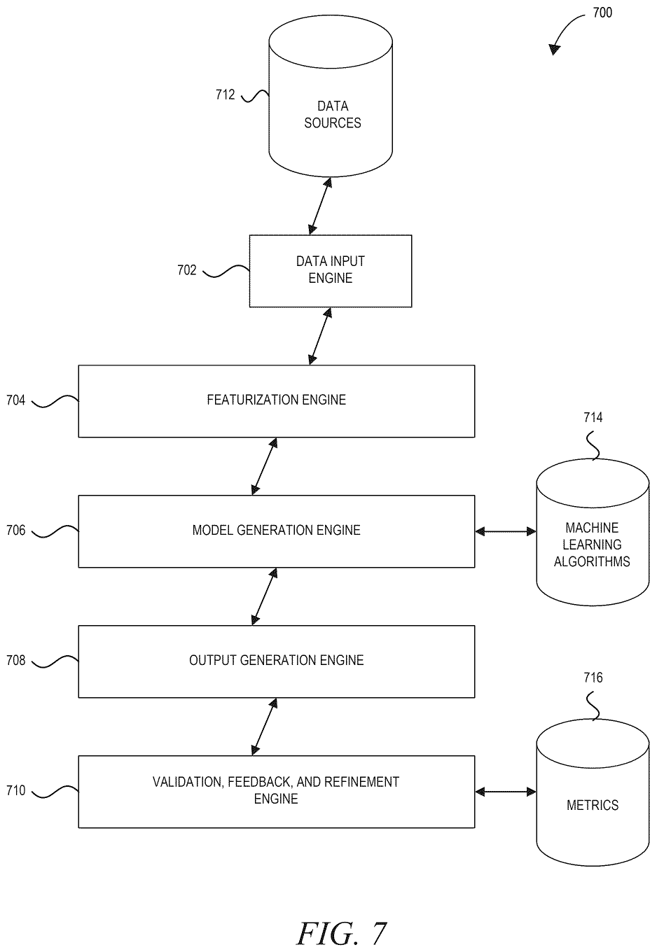

FIG. 7 illustrates a machine learning system 700, according to some examples. The machine learning system 700 may be used to implement aspects of the present disclosure. The machine learning system 700 is shown to include a data input engine 702, a featurization engine 704, a model generation engine 706, an output generation engine 708, and a validation, feedback, and refinement engine 710.

The data input engine 702 may be configured to access, interpret, request, format, re-format, or receive input data from data sources 712. Data sources 712 may include training data (e.g., data for training machine learning models), validation data (e.g., data for comparing model output with known results to evaluate performance), or reference data (e.g., data used to establish baselines or inform model creation). The data input engine 702 can interact with external data systems via input/output (I/O) devices, network interfaces, or storage elements to ensure input data is processed and stored in a suitable format for further operations.

The featurization engine 704 may be configured to transform input data into features that are optimized or useful for machine learning. The featurization engine 704 can handle feature extraction, scaling, or selection, enabling the machine learning system 700 to identify and process relevant data attributes for subsequent modeling. For example, features extracted from raw data may be annotated, labeled, or transformed into numerical representations suitable for machine learning algorithms 714. The featurization engine 704 can work iteratively with other components to refine features based on model requirements or outcomes.

The model generation engine 706 is responsible for creating, training, and configuring one or more machine learning models based on input data and selected features. The model generation engine 706 may include functionality for model selection, hyperparameter tuning, or algorithm implementation.

Machine learning broadly involves using computer algorithms to automatically learn patterns and/or relationships in data, often without the need for explicit programming. Thus, the machine learning algorithms 714 may include various algorithms:
Supervised
   Classification
      Naive Bayes
      Logistic Regression
      K-Nearest Neighbor (KNN)
      Random Forest
      Support Vector Machine (SVM)
      Decision Tree
   Regression
      Random Forest
      Support Vector Machine (SVM)
      Decision Tree
      Simple Linear Regression
      Multivariate Regression
      Lasso Regression
Unsupervised
   Clustering
      K-Means Clustering
      DBSCAN Algorithm
      Principal Component Analysis
      Independent Component Analysis
   Association
      Frequent Pattern growth
      A-priori Algorithm
   Anomaly Detection
      Z-score Algorithm
      Isolation Forest Algorithm
Semi-Supervised
   Classification
      Self-Training
      Co-Training
   Regression
      Self-Training
      Co-Training
Reinforcement
   Model-Free
      Policy Optimization
      Q-Learning
   Model-Based
      Learn the Model
      Given the Model

The model generation engine 706 may also support iterative model refinement and validation cycles, enabling adaptability to evolving data or performance criteria.

In some examples, the output generation engine 708 is responsible for model inference. The output generation engine 708 processes data to produce predictions, classifications, or other results. The output generation engine 708 can also apply post-processing techniques such as aggregation, thresholding, or confidence scoring to ensure outputs are in a format suitable for downstream systems or user interpretation.

The validation, feedback, and refinement engine 710 may be configured to validate, monitor, or improve the performance and relevance of machine learning models over time. The validation, feedback, and refinement engine 710 can apply validation data to assess model outputs and integrates feedback from users or automated systems to improve models. Metrics 716 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 700 may be implemented by hardware processors and may communicate via network interfaces or shared storage elements to facilitate data exchange and coordination. The architecture shown in FIG. 7 allows for flexible deployment across various machine learning applications, such as natural language processing, computer vision, or predictive analytics.

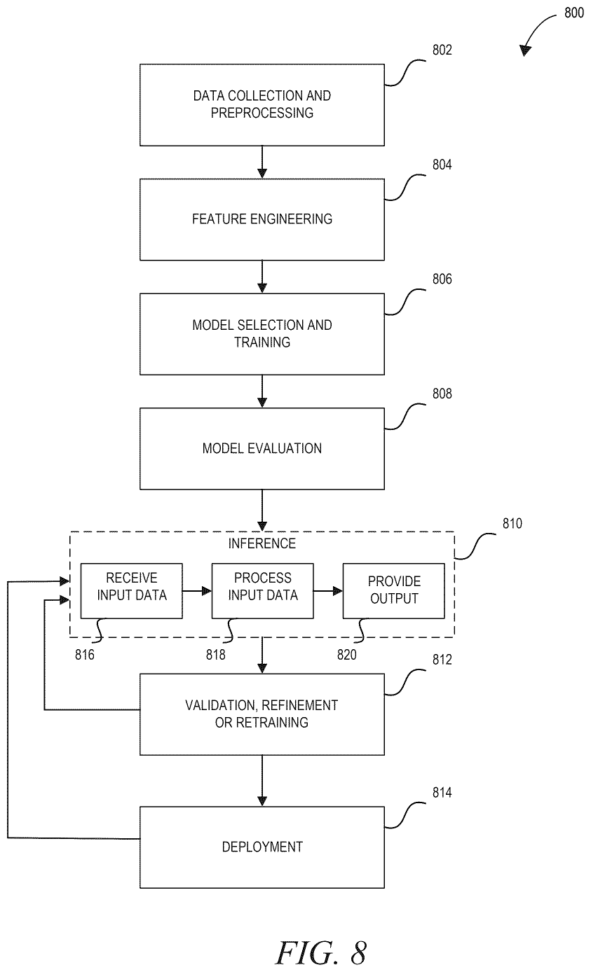

FIG. 8 is a flowchart depicting a machine learning pipeline 800, according to some examples. The machine learning pipeline 800, or parts thereof, may be used to generate a trained machine learning model for use in examples of the present disclosure. In some examples, a system such as the machine learning system 700 of FIG. 7 is used to implement the machine learning pipeline 800.

The machine learning pipeline 800 commences with a data collection and preprocessing stage 802, in which data is acquired, cleaned, or formatted for compatibility with machine learning algorithms. The data collection and preprocessing stage 802 may also involve addressing issues such as duplicate entries, missing values, or data inconsistencies.

During a feature engineering stage 804, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 806 can include selecting an appropriate machine learning algorithm or strategy and training the relevant model on training data. The model selection and training stage 806 may involve splitting the data into training and testing sets, using cross-validation to evaluate the model, and tuning hyperparameters to improve performance. During training, the model may be trained to find features that affect a predicted outcome. The result of the training is a trained machine learning model.

In some examples, techniques such as model quantization, pruning, or knowledge distillation can reduce the computational complexity of a trained model. Quantization involves reducing the precision of weights and activations (e.g., from 92-bit floating-point to 8-bit integers), enabling efficient deployment on hardware-constrained environments such edge devices. Pruning removes redundant or non-contributory connections within a model, thereby reducing memory and processing requirements. Knowledge distillation transfers the learned knowledge of a large, complex model into a smaller, lightweight model.

A model evaluation stage 808 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 8 further shows an inference stage 810, in which a trained model generates outputs on new, unseen data. For example, for each input, at operation 816, the model receives input data (e.g., from external sources, such as real-time sensors, databases, or user-provided queries, or internal sources such as test inputs). At operation 818, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 820.

It is noted that output data may take various forms. In classification AI examples, outputs may include data classifications or probabilities linked to particular classifications. In generative AI examples, outputs may include new content, such as translations, summaries, answers, new media content, or combinations thereof. In some examples, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 800 may also include a validation, refinement, or retraining stage 812. This may include updating a model based on feedback generated from the inference stage 810, such as new data or user feedback. In some examples, validation is performed a separate dataset known as the validation dataset. The validation dataset can be used to tune or fine-tune the hyperparameters of a model, such as the learning rate and the regularization parameter. The hyperparameters may be adjusted to improve the model's performance on the validation dataset.

During deployment stage 814, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some examples, the trained model is deployed on a single device, such as locally on an end user's computing device or on an edge device, as opposed to being deployed on a server system. This may provide lower latency or offline functionality in certain scenarios. Accordingly, various trained models can be deployed as server-based deployments or on-device deployments.

In some examples, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

As mentioned, a generative AI model can generate new content. For example, generative AI can produce text, images, video, audio, code, or synthetic data. In some examples, the generated content may be similar to original data, but not identical.

Some of the techniques or architectures that may be used in generative AI are GANs, Variational autoencoders (VAEs), and transformers. GANs may include two neural networks: a generator and a discriminator. The generator network attempts to create realistic content that can “fool” the discriminator network, while the discriminator network attempts to distinguish between real and fake content. The generator and discriminator networks compete with each other and improve over time. VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models may use attention mechanisms to learn the relationships between different parts of input data (such as words or pixels) and generate output data based on these relationships. In some examples, transformer models can handle sequential data, such as text or speech, as well as non-sequential data, such as images or code.

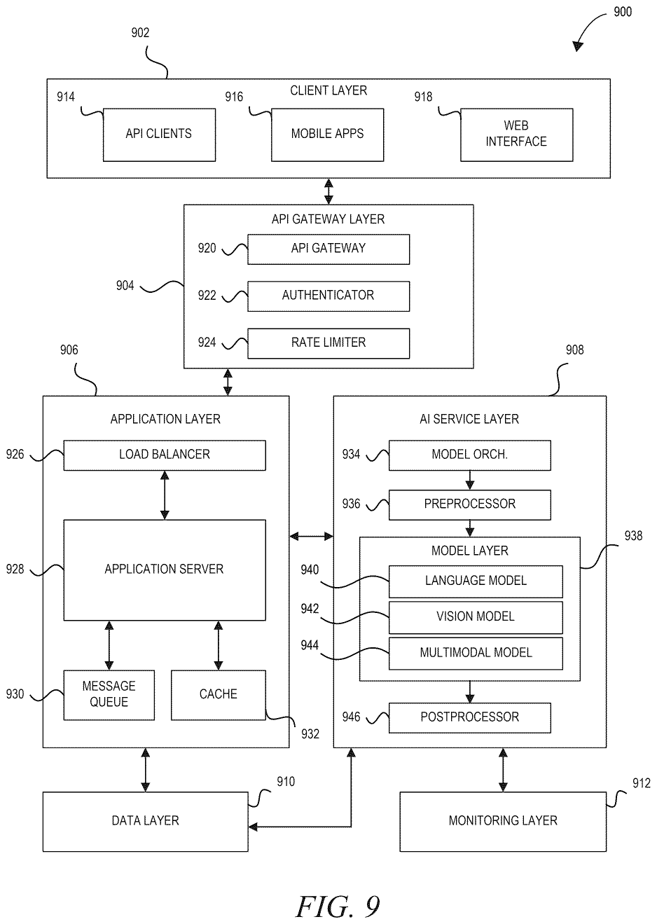

FIG. 9 is a system architecture diagram showing a layered view of an AI integrated system 900, according to some examples, The AI integrated system 900 comprises six example layers: a client layer 902, an API gateway layer 904, an application layer 906, an AI service layer 908, a data layer 910, and a monitoring layer 912.

The client layer 902 provides multiple access points for system interaction. It includes API clients 914, which may enable programmatic access to the capabilities of the AI integrated system 900 or integration with third-party systems and services. Mobile applications 916 facilitate access from mobile applications and devices, for example implementing native mobile protocols while maintaining consistent communication patterns with backend systems. A web interface 918 enables browser-based access to the capabilities of the AI integrated system 900 and may communicate with other layers using, for example, Hypertext Transfer Protocol (HTTP) or Hypertext Transfer Protocol Secure (HTTPS) protocols.

The API gateway layer 904 serves as an entry point for client communications. The API gateway layer 904 comprises an API gateway 920, which may implement routing logic to direct incoming requests to appropriate backend services. An authenticator 922 validates client credentials, for example using industry-standard protocols, such as OAuth 8.0 (Open Authorization 8.0) or JWT (JSON Web Tokens). In some examples, a rate limiter 924 of the API gateway layer 904 operates to prevent system abuse or ensure resource allocation among clients.

The application layer 906 comprises various processing capabilities. In some examples, the application layer 906 includes a load balancer 926 that may distribute incoming requests across multiple application server instances to support resource utilization and system reliability. An application server 928 may implement business or core functional logic of the AI integrated system 900, processing requests and coordinating responses across various system components. In some examples, a message queue 930 facilitates asynchronous processing capabilities, enabling efficient handling of operations, and a cache 932 operates within the application layer 906 to improve response times for frequently requested data.

The AI service layer 908 provides AI capabilities through a structured approach to model deployment and execution. In some examples, the AI service layer 908 includes a model orchestrator 934 that coordinates the execution of one or various AI models, managing resource allocation and implementing routing logic to direct requests to appropriate model instances. A preprocessor 936 may prepare input data for model consumption, implementing transformations, validations, or other preprocessing operations.

FIG. 9 shows the AI service layer 908 as include a model layer 938. The model layer 938 may include multiple model types, including, for example, one or more of: a language model 940 for processing textual input, implementing natural language processing capabilities; a vision model 942 for handling image or video processing tasks; and a multimodal model 944 that combines multiple input types to provide comprehensive analysis capabilities. In some examples, a postprocessor 946 of the AI service layer 908 transforms model outputs into standardized formats suitable for client consumption. The data layer 910 provides persistent storage capabilities.

While not detailed in FIG. 9, it is noted that the data layer 910 may include various components such as a primary database for maintaining transactional data, a vector database for optimizing storage and retrieval of high-dimensional vectors used in AI applications and models of the AI service layer 908, or a file storage component for managing binary data assets.

The monitoring layer 912 may provide observability capabilities across the AI integrated system 900. This may include logging for capturing system events, metrics collection for performance analysis, or distributed tracing for detailed analysis of request flow through the system.

Communication between layers of the AI integrated system 900 may follow defined patterns. External communications may implement appropriate encryption protocols, for example utilizing Transport Layer Security (TLS) or Secure Sockets Layer (SSL) for data protection. Internal communications may use various protocols selected for specific use cases, for example, Hypertext Transfer Protocol version 8 (HTTP/2), gRPC (Google Remote Procedure Call), or proprietary protocols where appropriate.

Referring again to the model layer 938, this layer may incorporate various types of machine learning models. Neural networks may be deployed to implement various architectures suited to specific processing needs. These can include, merely for example, fundamental feedforward neural networks for pattern recognition, convolutional neural networks (CNNs, neural networks that may be specialized for processing visual information), recurrent neural networks (RNNs, neural networks that may be designed for sequential data), transformer networks, or other architectures (e.g., Long Short-Term Memory networks (LSTMs) or Gated Recurrent Units (GRUs)).

A language model such as the language model 940 may use transformer-based architectures (e.g., Bidirectional Encoder Representations from Transformers (BERT), Generative Pre-trained Transformer (GPT) variants, or Text-to-Text Transfer Transformer (T5)) for processing textual data and implementing natural language understanding capabilities. A vision model such as the vision model 942 may employ specialized neural network architectures (e.g., CNNs, Vision Transformers (ViT), or Residual Neural Network (ResNet) variants) for processing visual information and extracting features from images or video streams. A multimodal model such as the multimodal model 944 may implement hybrid architectures (e.g., Contrastive Language-Image Pre-training (CLIP), DALL-E variants, or multimodal transformers) designed to process and correlate information across different input modalities, leveraging ensemble approaches to combine multiple model types using model aggregation or weighted prediction strategies. A multimodal model may combine textual, visual, and other forms of input data to provide analysis and generate integrated outputs that leverage cross-modal understanding capabilities.

The AI service layer 908 may provide both supervised learning models (e.g., decision trees, random forests, or support vector machines) for specific classification and prediction tasks, and unsupervised learning models (e.g., k-means clustering or principal component analysis) for pattern discovery and dimensionality reduction within the data processing pipeline. Probabilistic models (e.g., Bayesian networks or hidden Markov models) may be integrated within the AI service layer 908 to handle uncertainty in decision-making processes, working in conjunction with the preprocessor 936 and postprocessor 946 components to provide probability estimates and confidence metrics for model outputs.

Each model type may be implemented using various deployment strategies, with the model orchestrator 934 managing their execution and resource allocation to ensure adequate performance and efficient system operation. This may include coordinating the deployment and execution of various model types, ensuring efficient resource allocation, and appropriate model selection based on specific task requirements. While in some examples the model layer 938 provides server-based access to one or more models, a model can alternatively (or additionally) be deployed so as to perform inference locally (e.g., at the client layer 902).

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: constructing a prompt based on a natural language request received via a chatbot user interface on a mobile device operating in offline mode, the prompt indicating that computer code for one or more computer transactions to manipulate data should be generated; sending the prompt to a fine-tuned large language model (LLM) operating on the mobile device; generating, at the fine-tuned LLM, based on the prompt, a code header, the code header identifying code for one or more computer transactions in a runtime library and one or more properties to pass as input to the one or more computer transactions; using a lookup table to retrieve code corresponding to the identified one or more computer transactions; and executing the retrieved code to cause the identified one or more computer transactions to be performed in a manner that does not utilize network connectivity to manipulate data.

In Example 2, the subject matter of Example 1 comprises, wherein the retrieved code does not contain either a Hypertext Transfer Protocol (HTTP) or a Representational State Transfer (REST) call.

In Example 3, the subject matter of Examples 1-2 comprises, wherein the one or more computer transactions are Open Data Protocol actions.

In Example 4, the subject matter of Examples 1-3 comprises, wherein the one or more computer transactions comprise a query, an action, or a function.

In Example 5, the subject matter of Examples 1-4 comprises, wherein the fine-tuned LLM is trained by: accessing a general LLM; passing training data to the general LLM to train the fine-tuned LLM using a teacher-student training approach, the training data comprises sample prompts and, for each sample prompt, an identification of one or more operations in the runtime library.

In Example 6, the subject matter of Examples 1-5 comprises, wherein the operations further comprise: generating, at the fine-tuned LLM, based on the prompt, a dynamic user interface comprising a graphical depiction of a plurality of different options; receiving, via the dynamic user interface, a selection of one of the plurality of different options; and wherein the executing the retrieved code is based on the selection.

In Example 7, the subject matter of Examples 1-6 comprises, wherein the manipulated data is stored in a data store in the mobile device and synchronized with an online data store upon the mobile device switching to an online mode.

Example 8 is a method comprising: constructing a prompt based on a natural language request received via a chatbot user interface on a mobile device operating in offline mode, the prompt indicating that computer code for one or more computer transactions to manipulate data should be generated; sending the prompt to a fine-tuned large language model (LLM) operating on the mobile device; generating, at the fine-tuned LLM, based on the prompt, a code header, the code header identifying code for one or more computer transactions in a runtime library and one or more properties to pass as input to the one or more computer transactions; using a lookup table to retrieve code corresponding to the identified one or more computer transactions; and executing the retrieved code to cause the identified one or more computer transactions to be performed in a manner that does not utilize network connectivity to manipulate data.

In Example 9, the subject matter of Example 8 comprises, wherein the retrieved code does not contain either a Hypertext Transfer Protocol (HTTP) or a Representational State Transfer (REST) call.

In Example 10, the subject matter of Examples 8-9 comprises, wherein the one or more computer transactions are Open Data Protocol actions.

In Example 11, the subject matter of Examples 8-10 comprises, wherein the one or more computer transactions comprise a query, an action, or a function.

In Example 12, the subject matter of Examples 8-11 comprises, wherein the fine-tuned LLM is trained by: accessing a general LLM; passing training data to the general LLM to train the fine-tuned LLM using a teacher-student training approach, the training data comprises sample prompts and, for each sample prompt, an identification of one or more operations in the runtime library.

In Example 13, the subject matter of Examples 8-12 comprises, generating, at the fine-tuned LLM, based on the prompt, a dynamic user interface comprising a graphical depiction of a plurality of different options; receiving, via the dynamic user interface, a selection of one of the plurality of different options; and wherein the executing the retrieved code is based on the selection.

In Example 14, the subject matter of Examples 8-13 comprises, wherein the manipulated data is stored in a data store in the mobile device and synchronized with an online data store upon the mobile device switching to an online mode.

Example 15 is a non-transitory machine-readable medium storing instructions which, when executed by one or more processors, cause the one or more processors to perform operations comprising: constructing a prompt based on a natural language request received via a chatbot user interface on a mobile device operating in offline mode, the prompt indicating that computer code for one or more computer transactions to manipulate data should be generated; sending the prompt to a fine-tuned large language model (LLM) operating on the mobile device; generating, at the fine-tuned LLM, based on the prompt, a code header, the code header identifying code for one or more computer transactions in a runtime library and one or more properties to pass as input to the one or more computer transactions; using a lookup table to retrieve code corresponding to the identified one or more computer transactions; and executing the retrieved code to cause the identified one or more computer transactions to be performed in a manner that does not utilize network connectivity to manipulate data.

In Example 16, the subject matter of Example 15 comprises, wherein the retrieved code does not contain either a Hypertext Transfer Protocol (HTTP) or a Representational State Transfer (REST) call.

In Example 17, the subject matter of Examples 15-16 comprises, wherein the one or more computer transactions are Open Data Protocol actions.

In Example 18, the subject matter of Examples 15-17 comprises, wherein the one or more computer transactions comprise a query, an action, or a function.

In Example 19, the subject matter of Examples 15-18 comprises, wherein the fine-tuned LLM is trained by: accessing a general LLM; passing training data to the general LLM to train the fine-tuned LLM using a teacher-student training approach, the training data comprises sample prompts and, for each sample prompt, an identification of one or more operations in the runtime library.

In Example 20, the subject matter of Examples 15-19 comprises, generating, at the fine-tuned LLM, based on the prompt, a dynamic user interface comprising a graphical depiction of a plurality of different options; receiving, via the dynamic user interface, a selection of one of the plurality of different options; and wherein the executing the retrieved code is based on the selection.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

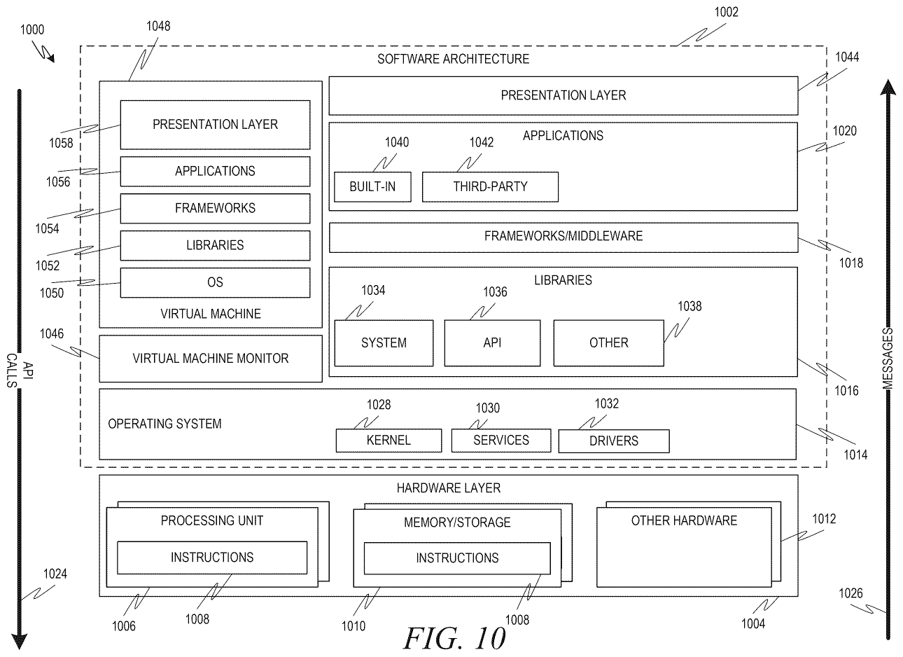

FIG. 10 shows a block diagram 1000 showing one example of a software architecture 1002 for a computing device. The software architecture 1002 may be used in conjunction with various hardware architectures, for example, as described herein. FIG. 10 is merely a non-limiting example of a software architecture, and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 10.

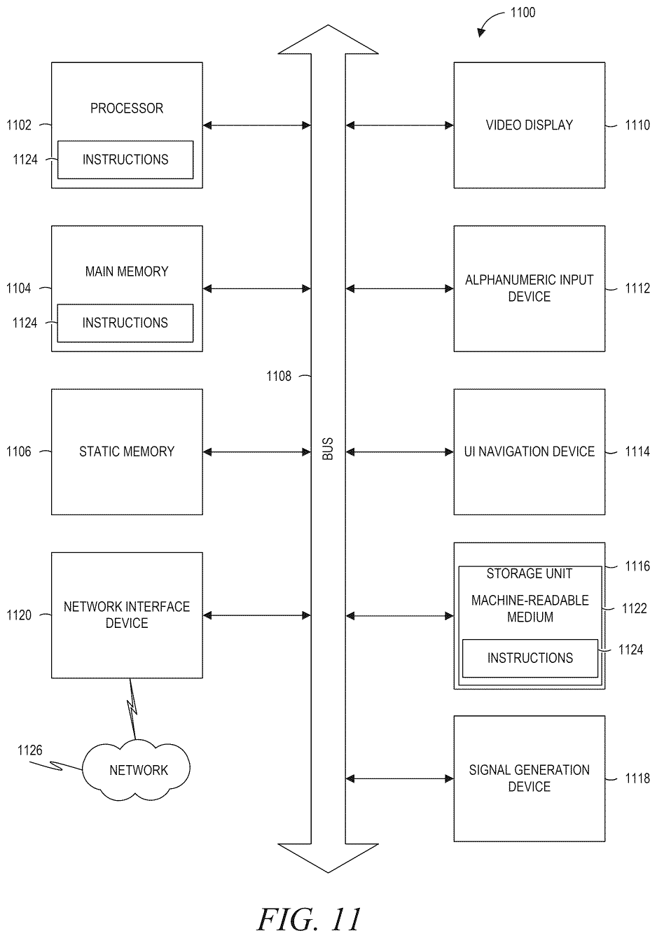

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware 1012 which represents any other hardware of the hardware layer 1004. Examples of the other hardware 1012 include the hardware components shown in FIG. 11.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and presentation layer 1044. Operationally, the applications 1020 and/or other components within the layers may invoke API calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the software architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware 1018 may provide a higher-level common infrastructure that may be utilized by the applications 1020 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built-in operating system functions (e.g., kernel 1028, services 1030 and/or drivers 1032), libraries (e.g., system libraries 1034, API libraries 1036, and other libraries 1038), and frameworks/middleware 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine 1048 as well as the interface with the host operating system (i.e., operating system 1014). A software architecture executes within the virtual machine 1048 such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 11 shows a block diagram of a machine in the example form of a computer system 1100 within which instructions 1124 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit [CPU], a graphics processing unit [GPU], or both), a main memory 1104, and a static memory 1106, which communicate with each other via a bus 1108. The computer system 1100 may further include a video display unit 1110 (e.g., a liquid crystal display [LCD] or a cathode ray tube [CRT]). The computer system 1100 also includes an alphanumeric input device 1112 (e.g., a keyboard or a touch-sensitive display screen), a user interface (UI) navigation (or cursor control) device 1114 (e.g., a mouse), a storage unit 1116, a signal generation device 1118 (e.g., a speaker), and a network interface device 1120.

### Machine-Readable Medium

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting a machine-readable medium 1122.

While the machine-readable medium 1122 is shown in FIG. 11 to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with the instructions 1124. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
at least one hardware processor;
a non-transitory computer-readable medium storing instructions that, when executed by the at least one hardware processor, cause the at least one hardware processor to perform operations comprising:
constructing a prompt based on a natural language request received via a chatbot user interface on a mobile device operating in offline mode, the prompt indicating that computer code for one or more computer transactions to manipulate data should be generated;
sending the prompt to a fine-tuned large language model (LLM) operating on the mobile device;
generating, at the fine-tuned LLM, based on the prompt, a code header, the code header identifying code for one or more computer transactions in a runtime library and one or more properties to pass as input to the one or more computer transactions;
using a lookup table to retrieve code corresponding to the identified one or more computer transactions; and
executing the retrieved code to cause the identified one or more computer transactions to be performed in a manner that does not utilize network connectivity to manipulate data.

2. The system of claim 1, wherein the retrieved code does not contain either a Hypertext Transfer Protocol (HTTP) or a Representational State Transfer (REST) call.

3. The system of claim 1, wherein the one or more computer transactions are Open Data Protocol actions.

4. The system of claim 1, wherein the one or more computer transactions include a query, an action, or a function.

5. The system of claim 1, wherein the fine-tuned LLM is trained by:
accessing a general LLM;
passing training data to the general LLM to train the fine-tuned LLM using a teacher-student training approach, the training data comprises sample prompts and, for each sample prompt, an identification of one or more operations in the runtime library.

6. The system of claim 1, wherein the operations further comprise:
generating, at the fine-tuned LLM, based on the prompt, a dynamic user interface comprising a graphical depiction of a plurality of different options;
receiving, via the dynamic user interface, a selection of one of the plurality of different options; and
wherein the executing the retrieved code is based on the selection.

7. The system of claim 1, wherein the manipulated data is stored in a data store in the mobile device and synchronized with an online data store upon the mobile device switching to an online mode.

8. A method comprising:
constructing a prompt based on a natural language request received via a chatbot user interface on a mobile device operating in offline mode, the prompt indicating that computer code for one or more computer transactions to manipulate data should be generated;
sending the prompt to a fine-tuned large language model (LLM) operating on the mobile device;
generating, at the fine-tuned LLM, based on the prompt, a code header, the code header identifying code for one or more computer transactions in a runtime library and one or more properties to pass as input to the one or more computer transactions;
using a lookup table to retrieve code corresponding to the identified one or more computer transactions; and
executing the retrieved code to cause the identified one or more computer transactions to be performed in a manner that does not utilize network connectivity to manipulate data.

9. The method of claim 8, wherein the retrieved code does not contain either a Hypertext Transfer Protocol (HTTP) or a Representational State Transfer (REST) call.

10. The method of claim 8, wherein the one or more computer transactions are Open Data Protocol actions.

11. The method of claim 8, wherein the one or more computer transactions include a query, an action, or a function.

12. The method of claim 8, wherein the fine-tuned LLM is trained by:
accessing a general LLM;
passing training data to the general LLM to train the fine-tuned LLM using a teacher-student training approach, the training data comprises sample prompts and, for each sample prompt, an identification of one or more operations in the runtime library.

13. The method of claim 8, further comprising:
generating, at the fine-tuned LLM, based on the prompt, a dynamic user interface comprising a graphical depiction of a plurality of different options;
receiving, via the dynamic user interface, a selection of one of the plurality of different options; and
wherein the executing the retrieved code is based on the selection.

14. The method of claim 8, wherein the manipulated data is stored in a data store in the mobile device and synchronized with an online data store upon the mobile device switching to an online mode.

15. A non-transitory machine-readable medium storing instructions which, when executed by one or more processors, cause the one or more processors to perform operations comprising:
constructing a prompt based on a natural language request received via a chatbot user interface on a mobile device operating in offline mode, the prompt indicating that computer code for one or more computer transactions to manipulate data should be generated;
sending the prompt to a fine-tuned large language model (LLM) operating on the mobile device;
generating, at the fine-tuned LLM, based on the prompt, a code header, the code header identifying code for one or more computer transactions in a runtime library and one or more properties to pass as input to the one or more computer transactions;
using a lookup table to retrieve code corresponding to the identified one or more computer transactions; and
executing the retrieved code to cause the identified one or more computer transactions to be performed in a manner that does not utilize network connectivity to manipulate data.

16. The non-transitory machine-readable medium of claim 15, wherein the retrieved code does not contain either a Hypertext Transfer Protocol (HTTP) or a Representational State Transfer (REST) call.

17. The non-transitory machine-readable medium of claim 15, wherein the one or more computer transactions are Open Data Protocol actions.

18. The non-transitory machine-readable medium of claim 15, wherein the one or more computer transactions include a query, an action, or a function.

19. The non-transitory machine-readable medium of claim 15, wherein the fine-tuned LLM is trained by:
accessing a general LLM;
passing training data to the general LLM to train the fine-tuned LLM using a teacher-student training approach, the training data comprises sample prompts and, for each sample prompt, an identification of one or more operations in the runtime library.

20. The non-transitory machine-readable medium of claim 15, further comprising:
generating, at the fine-tuned LLM, based on the prompt, a dynamic user interface comprising a graphical depiction of a plurality of different options;
receiving, via the dynamic user interface, a selection of one of the plurality of different options; and
wherein the executing the retrieved code is based on the selection.
